(19) United States
(12) Patent Application Publication
(10) Pub. No.: US 2005/0030552 A1
(43) Pub. Date: Feb. 10, 2005

(54) Method for measuring large components, especially the body of rail cars

(76) Inventors: Willi-Fred Boheim, Dahlewitz (DE); Udo Laschet, Viersen (DE); Horst Reller, Ubach-Palenberg (DE)

Correspondence Address: HARNESS, DICKEY & PIERCE, P.L.C., P.O.BOX 8910, RESTON, VA, 20195, US

(21) Appl. No.: 10/490,050

(22) PCT Filed: Sep. 20, 2002
(86) PCT No.: PCT/DE02/03526

(30) Foreign Application Priority Data
Sep. 21, 2001 (DE) 101-46-713.3

(51) Int. Cl. G01B 11/24

(52) U.S. Cl. 356/601

(57) ABSTRACT

The invention relates to a method for measuring large components, especially the body of rail cars, which is characterized by the following features: a) producing a stressfree position of the large component in which it is not buckled, by means of a mechanical corner force measuring device, b) producing a reference position of the large component, likewise using a corner force measuring device, c) measuring the z dimensions of the large component using an electronic, self-leveling all-round laser and laser receivers, said laser describing a horizontal plane and the receivers which are disposed on the large component or on the measuring adapters automatically searching the laser plane, and d) measuring the x dimensions and the y dimensions of the large component using a tachymeter.

This application is the national phase under 35 U.S.C. § 371 of PCT International Application No. PCT/DE02/03526 which has an International filing date of Sep. 20, 2002, which designated the United States of America and which claims priority on German Patent Application number DE 101 46 713.3 filed Sep. 21, 2001, the entire contents of which are hereby incorporated herein by reference.

### FIELD OF THE INVENTION

The invention generally relates to a method for measuring large components, especially the body of rail cars.

### BACKGROUND OF THE INVENTION

In rail vehicle construction, the measurement of car bodies is used to verify compliance with the geometric requirements for a series of selected dimensions on the basis of the requirements for acceptance of the raw structure, handing over to the next process steps and the final measurement. The prior art relating to this subject includes the German DIN Standard 25043, Part 1 of which describes the measurement principles including a definition of the terminology, and Part 2 of which describes the measurement processes, with the attachment 1 to Part 2 of DIN 25043 including a measurement sheet 4. The measurement of car bodies is also described in Deutschen Bahn AG [German Rail] document DS 98611.

The normal measurements based on these documents are regarded as being subject to the disadvantage that different methods are applied to the raw structures and to the completed car bodies in order to produce the reference orientation of the car bodies which has to be produced before the actual measurement of the car body contour is carried out, for example the manually monitored limiting twist method and hydraulically operating devices for corner force measurements. A further disadvantage for the measurement of car bodies which are located in the reference orientation is the traditional use of frameworks composed of wire or cord, verticals and the conventional length measurement technique. The further development of rail vehicles, particular for high-speed railroads, requires high measurement precision and, in the case of the previous measurement concept, thus involves not only a high degree of care but also use of a large number of qualified specialist personnel, over a lengthy time.

### SUMMARY OF THE INVENTION

An embodiment of the invention is based on an object of providing an exact measurement method using standard digitized measurement methods and integrated measured value recording, while at the same time reducing the labor cost and the time involved.

According to an embodiment of the invention, an object is achieved by a method which is suitable for measurement of the raw structures and for the final measurement of large components (such as car bodies and their production facilities), the method including:
a) production of the stress-free orientation of the large component in which it is not twisted, by a mechanical corner force measurement device,
b) production of the reference orientation of the large component, likewise with the aid of the corner force measurement device,
c) measurement of the z-dimensions of the large component by an electronic, self-leveling omnidirectional laser and laser receivers, with the laser covering a horizontal plane and the receivers which are arranged on the large component and/or on measurement adapters automatically searching the laser plane, and
d) measurement of the x-dimensions and y-dimensions of the large component by a tachymeter.

### DETAILED DESCRIPTION OF THE PREFERRED EMBODIMENTS

The method according to an embodiment of the invention makes use of a combination of a number of measurement devices which represent an overall system:
1. Omnidirectional laser—a high level laser, which is electronically self-leveling in three axes, for horizontal and vertical use.
2. Laser receiver—a receiver for rotation laser beams having an active sensor which moves over a defined measurement range and automatically searches for the center point of the laser beam or of the light plane, and then digitally indicates the position found. The receiver's zero point can be adjusted as required over the entire measurement range.
3. Tachymeter—a motor-driven optical theodolite system, which has a vertical and a horizontal graduated dial of a theodolite and, in addition, has an integrated distance measuring device for measurements with respect to reflectors which are located on the large part, as target marks. An adjustable heavy aluminum stand is used for the tachymeter.
4. A commercially available computer (PC) with a screen.
5. Adapter for recoding the measured values—for direct sampling of the measurement points on the car body during the measurement by means of the omnidirectional laser or tachymeter, with these adapters being matched to the vehicle-specific measurement points, to the two appliances mentioned above and to the software that is used.
6. Appropriate programs (Software) which are used interalia for handling the tachymeter, for transmission of measurement data to the PC and for the initial evaluation of this data.
   From the start of the measurement process, the users are guided through the entire program routine by way of a menu which is specifically matched to the requirements for measurement of the car bodies, with the respective vehicle-specific procedure to be carried out for the measurement in each case being programmed. The fundamental program procedure comprises the setting up of a coordinate system after which the user is guided to the measurement points in accordance with a predetermined test procedure, with these measurement points being defined in the test plan for that specific vehicle. The measured values are then exported and archived. The evaluation of the measurement results and, in the end, the production of measurement sheets for the car body (see DIN 25043) are then carried out by means of a further calculation program.
7. A mechanical, electrically operable corner force measurement device, equipped with four spindle fine linear movement devices, force sensors and adapters for the car body. The measurement device includes a movable control panel with the appropriate elements for driving the fine linear movement devices, for controlling the measurement procedure and for processing all of the measured values that are obtained from the force and linear movement measurement. The corner force measurement is based on the principle of minimized force differences. The purpose of this measurement is to set the twist-free orientation of the car body and to determine the center of gravity position and the nominal corner forces.

A special mobile test rig is provided for the measurement of car bodies and is equipped for the measurement cycle with the corner force measurement device and reference points which represent a dimensional reference system. The measurement points on the car body are measured on this basis.

The preconditions for carrying out the measurement process include the car body being located on the corner force test rig and its stress-free orientation being sent with the aid of the corner force measurement device before the measurement process is carried out. The z-dimensions are measured by way of the omnidirectional laser and special adapters in accordance with the procedure plan and test plan for the measurement points. The tachymeter is used for the measurement of the x-dimensions and of the y-dimensions, to be precise likewise in accordance with a procedure and test plan.

The advantages of the method according to an embodiment of the invention include, in particular, that exact and reproducible measurements are achieved, with high measurement accuracy, by the combination of the equipment that is used. Furthermore, the procedure for the measurement process is automated with the assistance of the described test equipment. Furthermore, inaccuracies can advantageously be eliminated by the use of leveled apparatuses.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for measurement of a large components comprising:
producing a stress-free untwisted orientation of the large component;
producing a reference orientation of the large component;
measuring a z-dimension of the large component using an electronic, self-leveling omnidirectional laser and laser receivers, the laser covering a horizontal plane and the receivers, arranged at least one of on the large component and on measurement adapters, automatically searching the laser plane; and
measuring x-dimensions and y-dimensions of the large component using a device other than the laser.

2. The method of claim 1, wherein the method is for measurement of a car body of a rail vehicle.

3. The method of claim 1, wherein the measuring of the x-dimensions and y-dimensions of the large component is done using a tachymeter.

4. The method of claim 1, wherein the producing a stress-free untwisted orientation of the large component is done using a mechanical corner force measurement device.

5. The method of claim 4, wherein the producing of a reference orientation of the large component is done with the aid of the corner force measurement device.

6. A method for measurement of a large component, comprising:
producing a stress-free untwisted orientation, and a reference orientation of the large component;
measuring a first dimension of the large component using an omnidirectional laser and at least one receiver, the laser covering a first plane, wherein the at least one receiver is arranged at least one of on the large component and on at least one adapter, and is adapted to automatically search the laser plane; and
measuring additional dimensions of the large component.

7. The method of claim 6, wherein the method is for measurement of a car body for a rail vehicle.

8. The method of claim 6, wherein the measuring of the additional dimensions includes measuring x-dimensions and y-dimensions of the large component.

9. The method of claim 6, wherein the measuring of the additional dimensions is done using a device other than the omnidirectional laser and at least one receiver.

10. The method of claim 6, wherein the measuring of the additional dimensions is done using a tachymeter.

11. The method of claim 10, wherein the measuring of the additional dimensions is done using a tachymeter.

12. The method of claim 6, wherein the producing of a stress-free untwisted orientation of the large component is done using a mechanical corner force measurement device.

13. The method of claim 12, wherein the producing of a reference orientation of the large component is done with the aid of the corner force measurement device.
